(19) United States
(12) Patent Application Publication
(10) Pub. No.: US 2008/0120184 A1
(43) Pub. Date: May 22, 2008

(54) Interactive Advertisement Mechanism on a Mobile Device

(75) Inventors: Michael Ernst Aufricht, Los Altos, CA (US); Rafael Zacharia Weinstein, San Francisco, CA (US); Geoffrey James Broadwell, Foster City, CA (US)

Correspondence Address: EDELL, SHAPIRO & FINNAN, LLC, 1901 RESEARCH BOULEVARD, SUITE 400, ROCKVILLE, MD, 20850, US

(73) Assignee: SYBASE 365, INC., Chantilly, VA (US)

(21) Appl. No.: 11/931,627

(22) Filed: Oct. 31, 2007

Related U.S. Application Data
(63) Continuation of application No. 09/864,293, filed on May 25, 2001.
Application No. 09/864,293 is a continuation-in-part of application No. 09/559,964, filed on Apr. 28, 2000, now Pat. No. 6,779,042.
Application No. 09/559,964 is a continuation-in-part of application No. 09/393,390, filed on Sep. 10, 1999, now abandoned.

(51) Int. Cl. G06Q 30/00

(52) U.S. Cl. 705/14

(57) ABSTRACT

The invention includes systems, methods, computer program products, and combinations and sub-combinations thereof for enabling interactive advertisements (as well as other objects) to be loaded on mobile devices (as well as other types of devices), and for users of mobile devices to operate with such interactive advertisements on their mobile devices in an interactive manner while in an off-line mode.

This application is a continuation application of pending application Ser. No. 09/864,293, “An Interactive Advertisement Mechanism on a Mobile Device,” filed May 25, 2001, which is a continuation-in-part application of application Ser. No. 09/559,964, “System, Method, and Computer Program Product for Enabling On-Device Servers, Offline Forms, and Dynamic Ad Tracking On Mobile Devices,” filed Apr. 28, 2000 (now U.S. Pat. No. 6,779,042), which is a continuation-in-part application of application Ser. No. 09/393,390, “Interactive Applications for Handheld Computers,” filed Sep. 10, 1999 (abandoned), all of which are incorporated by reference herein in their entireties.

### CROSS-REFERENCE TO RELATED APPLICATIONS

This patent application is potentially related to the following co-pending U.S. utility patent application, which is herein incorporated by reference in its entirety:

“System, Method, and Computer Program Product for Placement of Channels on a Mobile Device for Interactive Offline Communications,” Ser. No. (to be assigned), Attorney Docket No. 1933.0010007, filed concurrently herewith.

### BACKGROUND OF THE INVENTION

1. Field of the Invention

The present invention relates generally to mobile communications, and more particularly relates to technology for using interactive applications while on-line and off-line on mobile devices.

2. Related Art

A variety of mobile devices (such as personal data assistants, or PDAs) exist. Such mobile devices include ones based on the Palm operating environment and the Windows CE operating environment.

A variety of software applications for those mobile devices also exist. What does not exist is a mechanism that allows mobile devices to interact with advertisements. Thus, what is needed is a system, method, and computer program product for enabling interactive advertisements to be loaded on mobile devices and for users of mobile devices to operate with such interactive advertisements on their mobile devices in an interactive manner while in an off-line mode.

### SUMMARY OF THE INVENTION

Briefly stated, the invention includes systems, methods, computer program products, and combinations and sub-combinations thereof for enabling interactive advertisements (as well as other objects) to be loaded on mobile devices (as well as other types of devices), and for users of mobile devices to operate with such interactive advertisements on their mobile devices in an interactive manner while in an off-line mode.

These and additional features and advantages of the present invention will become more apparent from the detailed description set forth below when taken in conjunction with the drawings in which like reference characters generally identify corresponding elements throughout.

### BRIEF DESCRIPTION OF THE FIGURES

The accompanying drawings, which are incorporated herein and form part of the specification, illustrate embodiments of the present invention and, together with the description, further serve to explain the principles of embodiments of the invention.

FIG. 1A is a block diagram of an embodiment of the invention;

FIG. 1B is an alternative block diagram of an embodiment of the invention;

FIG. 1B1 is a block diagram of an example data processing unit useful for implementing items from FIGS. 1A and 1B;

FIGS. 1C, 1D, 1E, 1F, 1G, 1H, 1I, and 1J are used to generally describe embodiments of the invention;

FIG. 2 is a flow diagram representing a method for displaying an advertisement page on a mobile device according to an embodiment of the invention;

FIG. 3 is an exemplary interactive advertisement shown on a Palm device;

FIG. 4 is a block diagram of a mobile device having time and location modules/devices;

FIG. 5A is a flow diagram illustrating a real time content specific advertising method according to an embodiment of the invention;

FIG. 5B is a flow diagram illustrating an offline content specific advertising method according to an embodiment of the invention;

FIG. 6 is a flow diagram illustrating an advertiser targeted marketing process;

FIG. 7 is a flow diagram illustrating a method for sharing revenue between a server and a provider when a mobile device is operating in a real time mode of operation;

FIG. 8 is a flow diagram illustrating a method of revenue sharing between a server and a provider when a mobile device is operating in an offline mode of operation;

FIG. 9 is a flow diagram illustrating a method for dynamic advertisement rotation on a mobile device;

FIG. 10A is a diagram illustrating an example of a location specific interactive advertisement to be displayed on a mobile device;

FIG. 10B is a method for displaying location specific interactive advertisements on a mobile device according to an embodiment of the invention;

FIG. 10C is a flow diagram illustrating a method for offline content specific advertising according to an embodiment of the present invention;

FIG. 11 is an exemplary illustration of other devices or sources that may trigger the display of one or more advertisements on a mobile device according to an embodiment of the present invention;

FIG. 12 is an exemplary diagram illustrating an advertisement on a billboard that enables communication between an advertiser and a user of a mobile device via a transport mechanism; and

FIG. 13 is a flow diagram illustrating a method for enabling an advertiser to communicate with a user of a mobile device via a transport mechanism on a billboard advertisement.

### DETAILED DESCRIPTION OF THE PREFERRED EMBODIMENTS

### 1. Overview of Embodiments of the Present Invention

Embodiments of the present invention are briefly described in this section.

Briefly stated, the invention is directed to placing objects such as, but not limited to, Internet or Web content on data processing devices, and more particularly, placing interactive advertisements from the Internet or Web content on data processing devices, such as but not limited to mobile devices. Table 1 lists examples of such Internet content, although the invention is not limited to these examples.

TABLE 1
Internet Content
Internet content includes but is not limited to:

HTML
JavaScript ™
Channels
Java ™
ActiveX
Multimedia:
Images (e.g., JPEG, GIF, PNG, vector graphics, etc.)
Audio Files (e.g. MP3)
Video (e.g. AVI)
Streaming Content: Voice/Data/Video
Binary files
XML
Applications
Data Objects
Documents
Anything that can be delivered via a “browser”

Table 2 lists examples of mobile devices, although the invention is not limited to these examples.

TABLE 2
Mobile Devices
Mobile devices include but are not limited to:

Handheld Computers
Cellular Phones
Internet-enabled Phones
Pagers
Radios
TVs
Audio Devices
Car Audio Systems
Recorders
Text-to-Speech Devices
Bar-code Scanners
Net Appliances
Mini-browsers
Personal Data Assistants (PDAs)

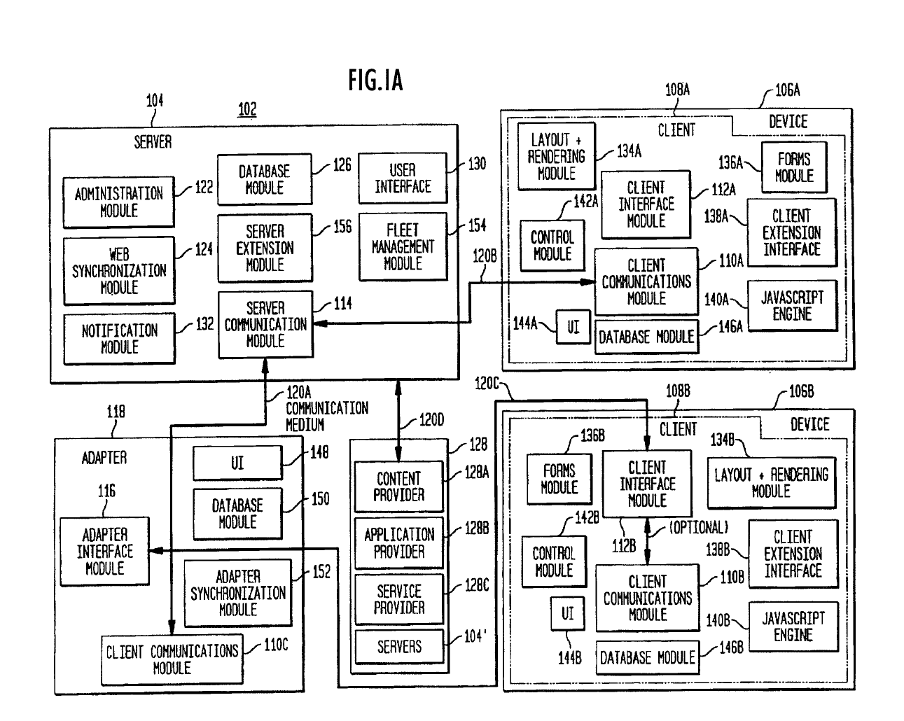

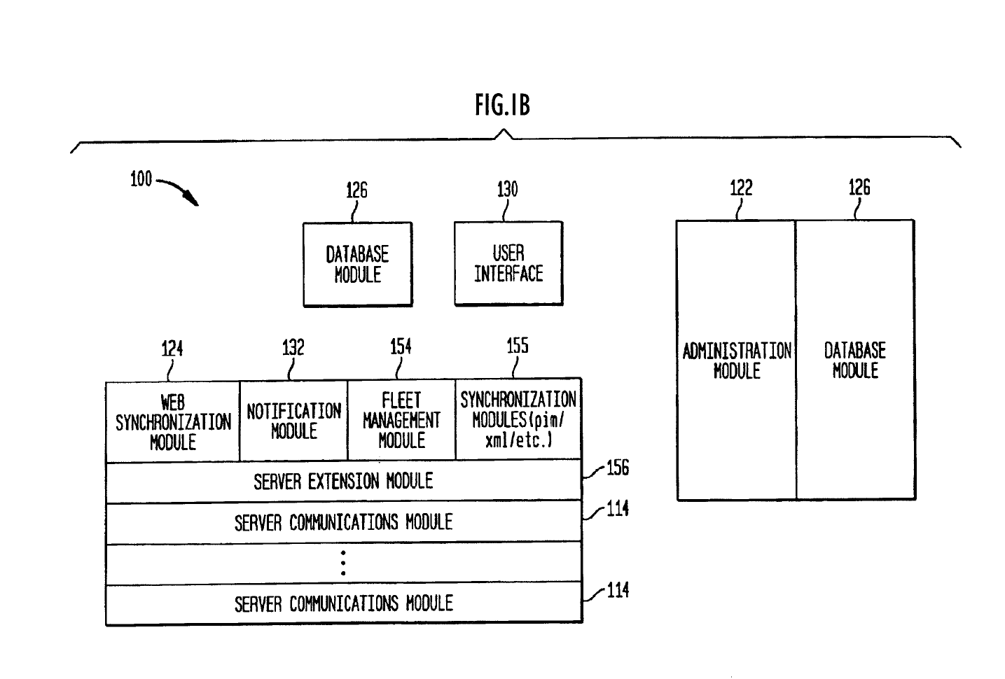

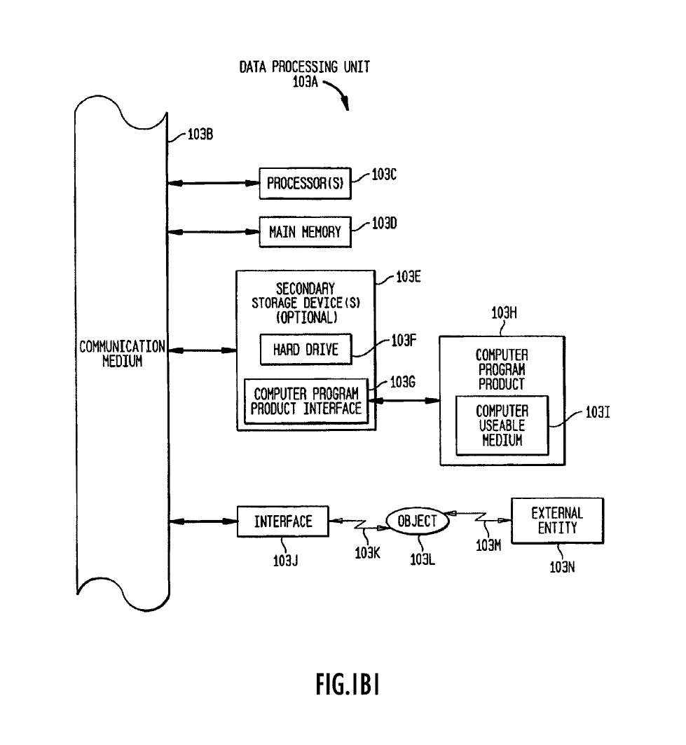

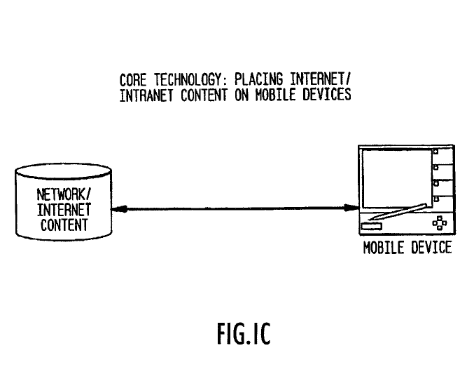

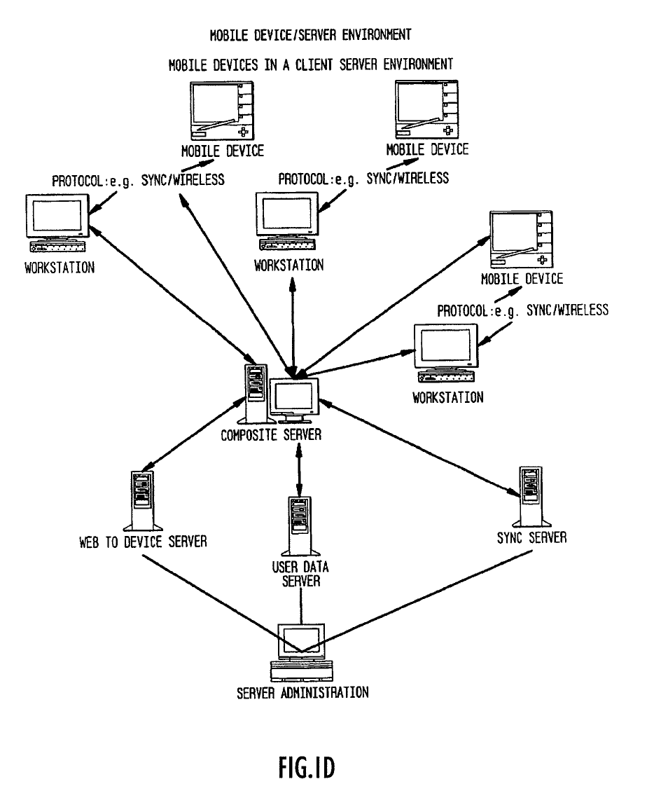

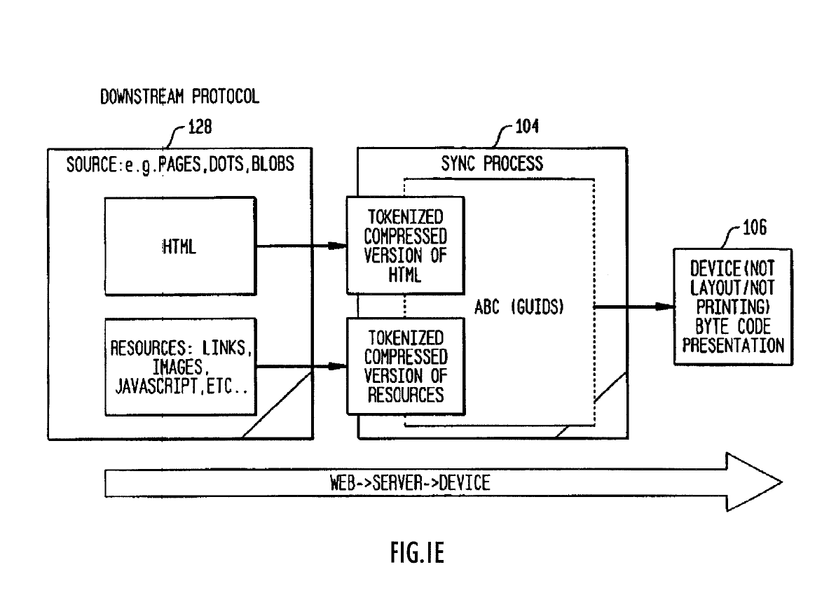

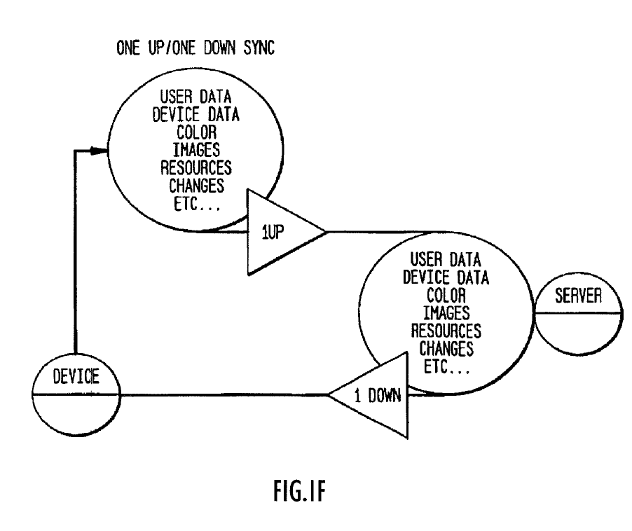

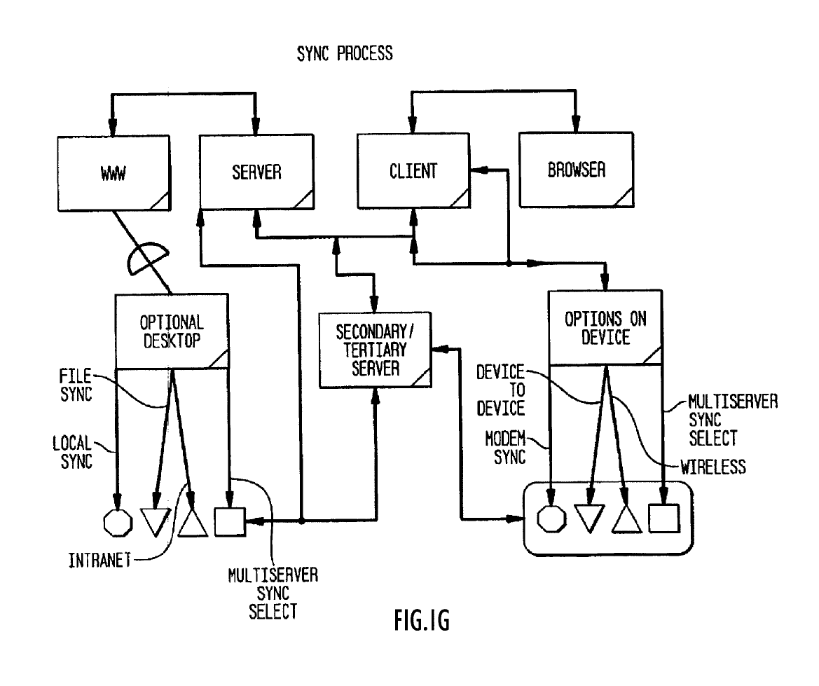

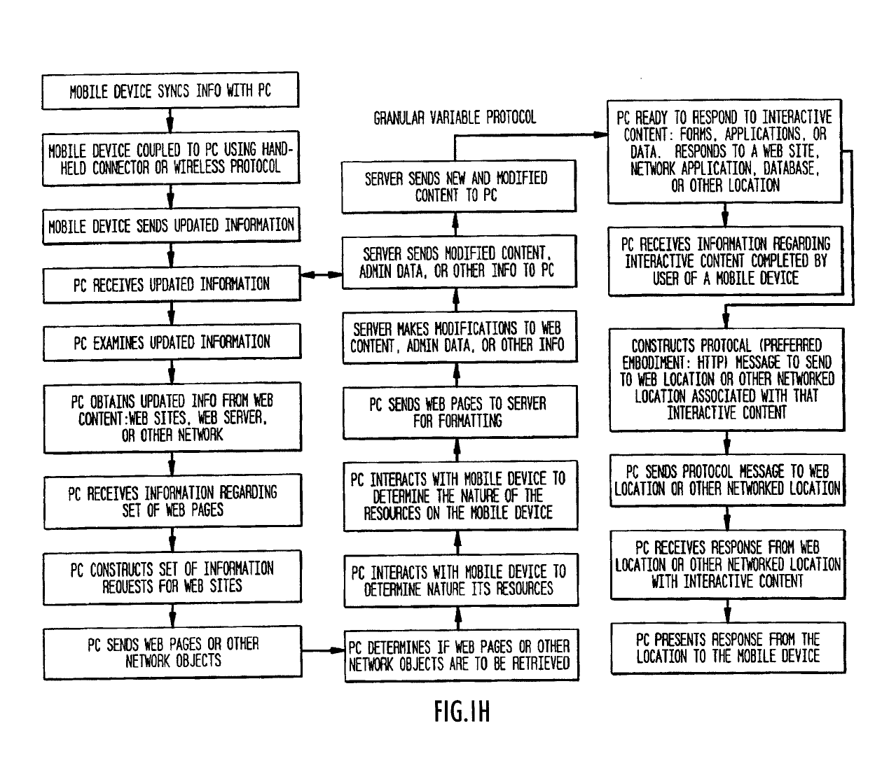

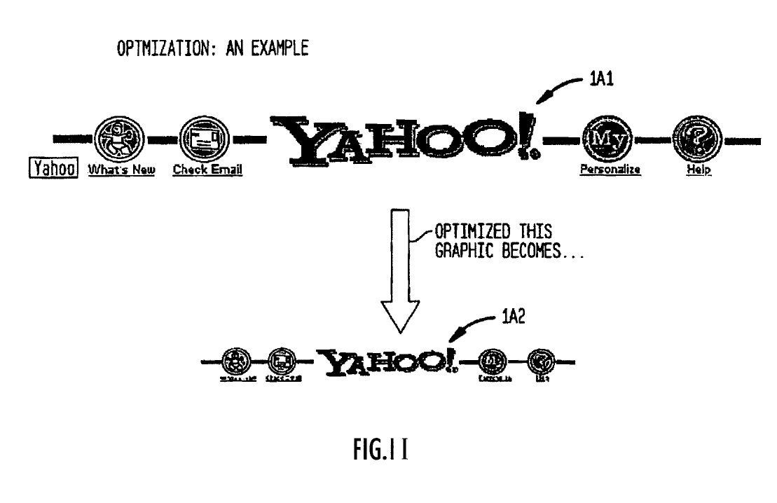

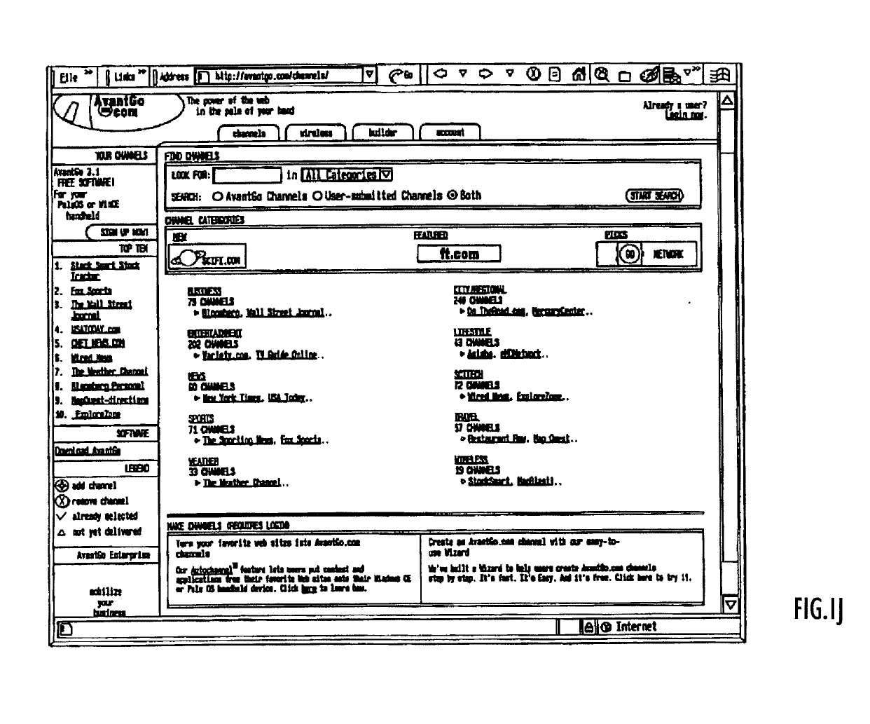

FIG. 1C illustrates a concept of the invention of placing objects, such as, but not limited to, advertisements on data processing devices, such as mobile devices. In one embodiment, the concept of placing objects on data processing devices is disclosed in more detail in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001), which is incorporated by reference herein in its entirety.

1.1. Enabling Mobile Devices to Interact with Networked Applications

The invention includes technology for using applications on mobile devices that interact with the Internet or with intranets. The invention enables applications available via a network or via an Internet/intranet to download and to run on mobile devices. Consequently, the invention includes software and methods for administering a server that manages the variables relevant to a mobile device/server environment.

The invention enables:

Mobile devices to operate in conjunction with a Web server, even when the mobile devices are not coupled directly to the PC using portable on-device servers: Web pages are loaded, viewed, cached, and deleted even when the device is not coupled to any network.

Mobile devices to operate in conjunction with the Web, Internet, or intranet via a connection mechanism and then in disconnected mode or with the Web, Internet, or intranet in wireless mode with a continuous or a discontinuous connection mechanism.

A technique for interactive connectivity between handheld computers and computer networks.

Fleet management for centrally administering information in a handheld network environment that includes, but is not limited to, user data, user groups, group channels, channel data, personal channels, commercial channels, user accounts, corporate account, software groupings, personal information management, form delivery, form management, device configuration, device databases, device contents, and devices parameters.

Obtaining updated Web pages and other network objects, for use when the mobile device is not communicating with the PC.

An example mobile device/server environment is shown in FIG. 1D.

1.2. Rapid Transfer of Web Pages to Mobile Devices

To improve efficiency of data exchange between mobile devices and networked content, the invention includes an improved communication protocol that collects requests and responses for network objects into a smaller number of protocol (such as HTTP) requests and responses. The server also determines the nature and the resources of the mobile device. This protocol is represented, for example, in FIG. 1E.

Downstream, the data is encoded in a data format called content stream (tokenized version of the data) and sent to the device. The content stream format creates a tokenized codification of HTML pages that is sent to the device. (The device receives the content stream and presents the material on the device.)

The HTML page is encoded into the content stream and sent to the device. The encoding is a mapping of parent and child HTML elements and/or resources to alphanumeric values.

The sync operation of the invention includes various synchronization processes that can collect information from the Internet to a server, and to the client. In embodiments, the usage of the term “sync” refers to the overall operation of connecting a client to a server for the exchange, interaction, creation, and removal of data.

In one embodiment, syncing can be defined as mirroring data on a client and a server, such that the data is the same on client and server. In other embodiments, syncing can be defined as overwriting data on a client or on a server, such that the data on either a client replaces the data on a server, and vice versa.

In one embodiment, a sync operation involves a user placing a mobile device into an adapter that includes a sync button. The adapter is connected to a server. Upon pressing the sync button, the user initiates the sync operations of the invention, which include various synchronization processes (specific delivery modes). Thus, the term sync is meant to refer to the overall operation of linking a client to a server. Synchronization is meant to refer to the specific process of copying, adding, filtering, removing, updating and merging the information between a client and a server. Any number of synchronization processes can be executed during a sync.

Before being sent downstream the data is compared to the data that is known to be on the client and then the client is updated all at once in a one-up/one-down synchronization method, which is represented in FIG. 1F. In an embodiment, the one-up/one-down synchronization process is disclosed in more detail in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001). The server sets the client to preemptively prepare all device information necessary during the sync. Then the server receives the set of information in a one-up fashion. The server collates the information and sends the information in a one-down fashion. This optimizes the sync's efficiency and speed. The sync process, according to embodiments of the invention, is represented in FIGS. 1G and 1H, and further described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

1.3. Optimizing Content of Web Pages for Mobile Devices

When Web content and other network objects pass through the server they are processed to minimize their size and to optimize their delivery to mobile devices: for presentation, for ease of use, for efficiency, for size, etc.

The invention uses server logic to optimize content. The server assesses the mobile device to optimize web content for the particular device. Factors that the server logic considers when performing this optimization include, but are not limited to (it is noted that the server may consider subsets of the following, depending on the application and implementation):

Dynamic memory specifications

High memory specifications

Protected Memory

Storage Memory

Database Memory

Available storage space

Screen size

User profile(s)

Color depth

Applications on device

Buttons on-device

Data markers (e.g., cookies, tokens)

Preferences

Fonts

Font specifications

Sync type

Synchronization types

Supported data types

Supported mime types

Connection/Network profile

An example optimization process is shown in FIG. 1I.

On the server, the graphic is optimized per the state information of the device. If the device sends down the need for the graphic on a page for a device with a display that is 27 cm wide and in grayscale, the server sends its best version of a graphic optimized for that environment. In one embodiment, the optimization process is disclosed in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The technology of the invention is extended by tags on HTML pages that identify content that is designed for additional modifications. Bytes processed by the server are potentially examined for compression/optimization. The server detects the tag and executes the necessary logic.

Table 3 illustrates example tags (the invention is not limited to the tags shown in Table 3).

TABLE 3
Sample Markup Language

| Tag | Effect |
|---|---|
| <META | This tag enables several HTML |
| NAME=“Handheld- | features that are normally turned off. |
| Friendly” | Most notably, The invention does not |
| content=“True”> | try to display TABLE tags or the |
| | HSPACE and VSPACE attributes of |
| | IMG tags unless the page is marked as |
| | “HandheldFriendly”. Most TABLEs or |
| | H/VSPACEs are designed for much |
| | larger screens. |
| <AGIGNORE></AGIGNORE> | Used in a wireless channel. Use the |
| | AGIGNORE tag to surround content |
| | within an HTML page that may be |
| | inappropriate or unattractive on |
| | Internet-enabled phones. |
| <AGPAGEBREAK | Used in a wireless channel. Breaks up |
| TITLE=“your | pages on request. When processing |
| title”> | pages for devices other than WAP |
| | phones, the server ignores the |
| | AGPAGEBREAK tag. |

### Web Content Aggregation, Web Channel Development, and Web Content Delivery for Users of the Internet and of Mobile Devices

The invention is extended by the coupling of devices to the content available at the server web site (see the example shown in FIG. 1J).

These and other embodiments of the present invention are described in greater detail below.

### Structural Embodiments of the Present Invention

Prior to describing the invention in detail, a data processing environment in which the present invention may be implemented is provided. FIG. 1A is a block diagram of a data processing environment 102 according to an embodiment of the invention. The data processing environment 102 includes a server 104 (although only one server 104 is shown, in practice the data processing environment 102 may include a plurality of servers), one or more devices 106, one or more adapters 118, and one or more providers 128.

Generally, the server 104 maintains a collection of channels. In an embodiment, a channel comprises a collection of objects. An object is any entity that can be transferred to a client 108, such as but not limited to content, applications, services, images, movies, music, links, etc.

A channel includes a number of properties. At least some of these properties define the objects that the channel includes. Such properties include, but are not limited to, the following (properties of channels may vary depending on the application and/or implementation):

A name of the channel.

A location of a root object (such as but not limited to a URL). In an embodiment, this root object is included in the channel. An indication of the number of levels below the root object, for which to include objects in the channel. For example, in an embodiment, if this property is equal to “1 level,” then all objects that are 1 level down from the root object (reached by traversing links in the root object), are included in the channel. If this property is equal to “2 levels,” then all objects that are 1 level down from the root object (reached by traversing links in the root object), and all objects that are 1 level down from those objects (reached by traversing links in those objects), are included in the channel. Embodiments of the invention allow “uneven” trees, where some branches of the tree extent to a greater number of levels than other branches of the tree. In other embodiments, the trees are even or balanced.

A maximum size of the channel. For example, if this is set to 500 Kbytes, then the aggregate size of the objects in the channel cannot be greater than 500 Kbytes. If the aggregate size of the objects in the channel is greater than this value, then embodiments of the invention may delete objects from the channel and/or delete portions of objects in the channel.

An indication of which resource objects are enabled for the channel:

An indication of whether or not images are to be included in or excluded from objects in the channel; and

An indication of whether or not scripts are enabled in objects in the channel.

A refresh methodology.

It is noted that the properties associated with channels may vary from implementation to implementation. Also, implementations may employ combinations of the above properties, and/or properties in addition to the following, as will be appreciated by persons skilled in the relevant art(s).

The invention includes processes for managing channels, including but not limited to adding channels to the collection of channels maintained by the server 104.

The server 104 offers channels to clients 108. A user associated with or on behalf of a client 108 may access the server 104 and view the collection of channels. The client 108 (via the user, for example) may then select any combination of the channels in the collection. The server 104 maintains a list of the channels associated with each of the clients 108.

During a synchronization process, the server 104 loads a device 108 with the channels associated with the client 108. Generally, the server 104 does this by obtaining from providers 128 the objects defined by the channels, and causing those objects to be stored on the client 108. Thus, during the synchronization process, the server 104 will load the client 108 with the selected channels. More particularly, the server 104 will load the client 108 with the objects associated with the channels.

The client 108 may process and use those objects when not connected to the server 104. The invention enables the client 108 to actively interact with the objects and channels.

In one embodiment, the client 108A directly interacts with the server 104 via some transmission medium 120B, which may be any wired or wireless medium using any communication protocol.

In another embodiment, the client 108B indirectly interacts with the server 104 via an adapter 118. For example, the client 108B may be a mobile device (such as a Palm device) and the adapter 118 may be a cradle and a computer coupled to the cradle (the mobile device is inserted into the cradle). In this instance, the adapter 118 presents itself to the server 104 as a client 108B (via client communications module 110C). When the server 104 sends objects to the adapter 118, the adapter interface module 116 writes those objects to client 108B. In embodiments, adapter interface module 116 can be a Hot Sync™ Manager, an Active Sync™, etc. It is noted that the invention is not limited to any of the implementation examples discussed herein.

The components shown in FIG. 1A shall now be described in greater detail.

The server 104 includes an administration module 122, a database module 126, a user interface 130, a web synchronization module 124, a server extension module 156, a fleet management module 154, a notification module 132, and a server communication module 114. Other embodiments of server 104 may include a subset of these modules, and/or may include additional modules.

The administration module 122 controls and manages the states of the server 104 and the clients 108. For example, the administration module 122 manages and controls groups of clients 108, permissions assigned to clients 108, groups, and channels. For example, the administration module 122 administers the users/clients 108 assigned to groups, and the channels associated with users. These and additional functions performed by the administration module 122 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The database module 126 controls access to databases associated with the server 104. The database module 126 maintains information relevant to the clients 108, as well as information relevant to the modules contained in the server 104. The database module 126 manages information on the collection of channels maintained by server 104. These and additional functions performed by the database module 126 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The user interface 130 is, in an embodiment, a graphical user interface (GUI) that enables users and clients 108 to access functions and modules offered by the server 104. More generally, the user interface 130 within server 104 provides access to server 104 and the modules and resources contained therein.

The invention supports various server web sites that are available through any communication medium, such as but not limited to the Internet, intranets, direct dial up links, etc. The UI 130 enables such web sites.

These and additional functions performed by the user interface 130 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The web synchronization module 124 is an application/instance of server extension module 156, and controls synchronization of web content to client 108. The invention may include other synchronization modules (which are application/instances of server extension module 156) that control synchronization of other types of objects to clients 108. For example, the server 104 may administer a calendar that may be installed on clients 108. The synchronization of appointments, events and/or dates on this calendar between clients 108 and the server 104 may be performed by a calendar synchronization module. These and additional functions performed by the server extension module 156 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The fleet management module 154 performs functions associated with fleets of clients 108, which are groups of clients 108. For example, fleet management module 154 may perform global or mass operations on groups (fleets) of clients 108, such as loading or updating an application on groups (fleets) of clients 108. Another example of a mass operation is retrieval of information on clients 108 in a fleet, such as the free memory in clients 108 in a fleet (this would help an organization determine if its clients 108 need a memory upgrade). These and additional functions performed by the fleet management module 154 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The server extension interface/module 156 enables modules, such as third party modules, to operate in or work with the server 104 (and modules contained in the server 104). The server extension module 156 presents an API (application programming interface). Modules in the server 104 may operate with other devices in the server 104 by conforming to the server API.

For example, the web synchronization module 124 and the fleet management module 154 (as well as other types of synchronization modules, not shown in FIG. 1A) may interact with databases on the server 104 via the database module 126 by going through the server extension module 156. The web synchronization module 124 and the fleet management module 154 may not be able to interact directly with the database module 126 for a number of reasons. For example, they may support different data formats, or simply “speak different languages.” However, they can interact via the server extension module 156 as well as other server modules as long as they conform to the API of the server extension module 156. This is true of any modules in the server 104, or that interact with the server 104.

Server communication module 114 enables communication between the server 104 and entities external to the server 104, such as clients 108, adapters 118, providers 128, work stations, etc. The server 104 communicates with these entities via communication mediums 120, which may be any type of wireless or wired communication using any protocol. It is noted that multiple server communication modules 114 may execute in a single server 104. For example, in one embodiment, server communication module 114 is a TCP/IP stack. In another embodiment, server communication module 114 is a secure socket layer stack or a compression stack. The invention is not limited to any implementation examples discussed herein. These and additional functions performed by the server communication module 114 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The notification module 132 sends objects to clients 108 beyond objects related to channels associated with clients 108. Such objects could be requested by client 108 in advance. For example, a client 108 could ask for a notification when an event happens, such as when a stock reaches a target price. When the event occurs, the notification module 132 would cause an appropriate notification(s)/object(s) to be sent to the client 108. Alternatively, the notification module 132 may send objects to clients 108 without any prior explicit request from the client 108. For example, the notification module 132 might send channels to clients 108 when such channels are identified to be similar to those already selected by the clients 108. Also, the notification module 132 might send appropriate notifications/objects to the clients 108 when such clients 108 receive email or faxes at the server 104. In embodiments, the notification module 132 transmits such objects to the client 108 immediately when the event occurs, during the next synchronization with the client 108, or at some other future synchronization.

An alternative representation of server 104 is shown in FIG. 1B. FIG. 1B illustrates, for example, that messages from entities outside of server 104 are received by server extension interface/module 156 via server communications modules 114. Generally, such messages represent requests for the server 104 to perform various functions. The server extension module 156 conceptually operates as a dispatcher who routes such messages to other modules contained in the server 104, such as web synchronization module 124 (who handles requests to synchronize with web content), notification module 132, fleet management module 154 (who handles fleet related requests), and/or third party modules 155 (such as other synchronization modules). Thus, the invention supports modules 155 generated by third parties to perform various functions. Such modules 155 “plug-in” to the server 104 via the server extension module 156.

Referring again to FIG. 1A, the devices 106 may be any type of data processing device. In embodiments of the invention, the devices 106 are mobile computing devices, although the invention is not limited to these embodiments. In such example embodiments, the devices 106 may include, but are not limited to, handheld computers, cellular phones, internet-enabled phones, pagers, radios, tvs, audio devices, car audio systems, recorders, text-to-speech devices, bar-code scanners, net appliances, mini-browsers, personal data assistants (PDAs), etc.

In embodiments of the invention, the devices 106 include software, hardware, and/or combinations thereof related to client functionality (such client functionality is described herein). When a device 106 includes such software, hardware, and/or combinations thereof, the device 106 is referred to herein as a client 108. Accordingly, it can be said that the data processing environment 102 includes one or more clients 108.

Clients 108 each may include a layout and rendering module 134, a forms module 136, a control module 142, a user interface 144, a client extension interface 138, a client interface module 112, a client communications module 110, a JavaScript™ engine 140, and a database module 146. Other embodiments W of clients 108 may include a subset of these modules, and/or may include additional modules.

Layout and rendering module 134 controls the processing of data objects on client 108, such as the layout and rendering of data objects on client 108. For example, the layout portion of module 134 obtains information from databases of the client 108 (via the database manager 146) and determines where such information should be rendered on the display of the client 108. Such information may include anything that can be rendered, such as but not limited to images, text, links, etc. The rendering portion of module 134 is responsible for drawing items on the display (drawing bits to the screen). These and additional functions performed by the layout and rendering module 134 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The forms module 136 controls and manages forms. For example, in embodiments the forms module 136 manages aspects of off-line forms, such as HTML forms and/or multi-page forms. The forms module 136 enables access to and user interaction with forms (in some embodiments, the forms module 136 via UI 144 enables users of client 108 to directly access forms). The forms module 136 maintains the status of forms. Forms module 136 can also include a forms manager (not shown) to provide added functionality. These and additional functions performed by the forms module 136 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The user interface 144 is preferably a graphical user interface that enables users to interact with client 108 and functions and modules provided by the client 108. More generally, UI 144 controls how functions presented by modules of the client 108 are presented to users. The UI 144 controls how users interact with such functions and modules. It is noted that the functionality of the UI 144 may be distributed. For example, portions of the UI 144 may reside in the forms module 136, as well as other modules of client 108. These and additional functions performed by the user interface 144 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The client extension interface 138 enables modules, such as third party modules, to operate in or work with the client 108 (and modules contained in the client 108). The client extension interface 138, also known as an on-device server, presents an API (application programming interface) that is, in embodiments, common to clients 108 on many architectures.

Modules in the client 108 can work together via the client extension interface 138. For example, the JavaScript™ engine 140 may decide that it wishes to display a message to the user. To do this, the JavaScript™ engine 140 would work through the client extension interface 138 to cause the UI 144 to display the message to the user. The JavaScript™ engine 140 may not know how to directly interact with the UI 144. However, as long as both the JavaScript™ engine 140 and the UI 144 conform to the API of the client extension interface 138, then they can operate together.

Similarly, the control module 142 may decide that it needs to store some data in a database. The control module 142 would do this by working with the client extension interface 138 to access the database module 146 to effect such a modification to the databases in the client 108. These and additional functions performed by the client extension interface 138 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The JavaScript™ engine 140 executes objects written in the JavaScript™ language that operate on client 108. As noted, the JavaScript™ engine 140 conforms to the API of the client extension interface 138, and works with the client extension interface 138 to work with other modules in client 108. These and additional functions performed by the JavaScript™ engine 140 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

Although not shown in FIG. 1A, embodiments of the invention include other engines for executing other types of scripts on client 108. These other engines can interact with other modules on client 108 as long as the engines conform to the API of the client extension interface 138.

The database module 146 controls access to databases associated with client 108. More generally, the database manager 146 controls access to resources on the client 108. For example, the control module 142 may interact with the database manager 146 to open an address book in the databases, and to write a record to the address book. Alternatively, the forms module 136 can interact with the database module 146 to access forms that are stored in the databases. These and additional functions performed by the database module 146 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

Client communications module 110 enables the client 108 to interact with external entities, such as server 104. In embodiments, the client communications module 110 enables TCP/IP traffic, although the invention is not limited to this example. More generally, the client communications module 110 enables communication over any type of communication medium 120, such as wireless, wired, etc., using any communication protocol, such as a pager protocol. These and additional functions performed by the client communications module 110 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001). The client interface module 112 enables the client 108 to communicate with adapters 118. Client interface module 112 optionally links to client communications module 110 in some embodiments to provide functionality (for example, when the client communications module 110 uses a wireless modem's drivers, which are accessed via client interface module 112). In embodiments, the client interface module 112 may be Hot Sync™ Manager in the Palm operating environment, or Active Sync™ in the Windows CE™ operating environment, or Pilot Link™ in the Unix operating environment. It is noted that these implementation examples are provided for illustrative purposes only. The invention is not limited to these examples. These and additional functions performed by the client interface module 112 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

The control module 142 coordinates the activities of the other modules in client 108 so that all the modules share resources properly. For instance, control module 142 can determine priorities for shared resources such as processing time, accessing memory, etc.

Providers 128 are sources of various types of objects, such as but not limited to content (content providers 128A), applications (application providers 128B), services (service providers 128C), etc. Providers 128 may also include servers 104′ (similar to server 104), which may provide objects such as but not limited to content, applications, services, etc. For example, and without limitation, the application providers 128B may provide objects relating to (without limitation) operating system updates/changes, system upgrades, application updates/changes, etc.

Adapters 118 include an adapter interface module 116, a user interface 148, a database module 150, an adapter synchronization module 152, and a client communications module 110. Other embodiments of adapters 118 may include a subset of these modules, and/or may include additional modules.

Client communications module 110 is the same as similarly named modules in clients 108.

The adapter interface module 116 enables the adapter 118 to communicate with clients 108.

The adapter synchronization module 152 is involved with synchronization operations between server 104 and clients 108.

The UI 148 enables users to interact with modules and functions of adapter 118.

The database module 150 controls access to databases associated with adapter 118. The database module 150 manages information needed for clients 108 to remain in sync with server 104. In some embodiments, the adapter 118 does not include the database module 150 or the UI 148 (i.e., in embodiments where the adapter 118 operates essentially as a pipe, as in some embodiments on Unix).

These and additional functions performed by modules of the adapter 118 are described in co-pending application entitled “System, Method, and Computer Program Product for Enabling On-Device Servers, Offline Forms, and Dynamic Ad Tracking On Mobile Devices,” Ser. No. 09/559,964, filed on Apr. 28, 2000 (Atty. Docket No. 1933.0010001).

Additional features of embodiments of the invention are described below.

1.4 Example Implementation Embodiments

FIG. 1B1 illustrates a block diagram of a data processing unit 103A that can be used to implement the entities shown in FIGS. 1A and 1B. It is noted that the entities shown in FIGS. 1A and 1B may be implemented using any number of data processing units 103A, and the configuration actually used is implementation specific.

Data processing unit 103A may represent laptop computers, hand held computers, lap top computers, and/or any other type of data processing devices. Which type of data processing device used to implement entities shown in FIGS. 1A and 1B is implementation specific.

Data processing unit 103A includes a communication medium 103B (such as a bus, for example) to which other modules are attached.

Data processing unit 103A includes one or more processor(s) 103C, and a main memory 103D. Main memory 103D may be RAM, ROM, or any other memory type, or combinations thereof.

Data processing unit 103A may include secondary storage devices 103E, such as but not limited to hard drives 103F or computer program product interfaces 103G. Computer program product interfaces 103G are devices that access objects (such as information and/or software) stored in computer program products 103. Examples of computer program product interfaces 103G include, but are not limited to, floppy drives, ZIP™ drives, JAZ™ drives, optical storage devices, etc. Examples of computer program products 103H include, but are not limited to, floppy disks, ZIP™ and JAZ™ disks, memory sticks, memory cards, or any other medium on which objects may be stored.

The computer program products 103H include computer useable mediums in which objects may be stored, such as but not limited to optical mediums, magnetic mediums, etc.

Control logic or software may be stored in main memory 103D, secondary storage device(s) 103E, and/or computer program products 103H.

More generally, the term “computer program product” refers to any device in which control logic (software) is stored, so in this context a computer program product could be any memory device having control logic stored therein. The invention is directed to computer program products having stored therein software that enables a computer/processor to perform functions of the invention as described herein.

The data processing unit 103A may also include an interface 103J which may receive objects (such as data, applications, software, images, etc.) from external entities 103N via any communication mediums including wired and wireless communication mediums. In such cases, the objects 103L are transported between external entities 103N and interface 103J via signals 103K, 103M. In other words, such signals 103K, 103M include or represent control logic for enabling a processor or computer to perform functions of the invention. According to embodiments of the invention, such signals 103K, 103M are also considered to be computer program products, and the invention is directed to such computer program products.

### 2. Interactive Advertisements on a Mobile Device

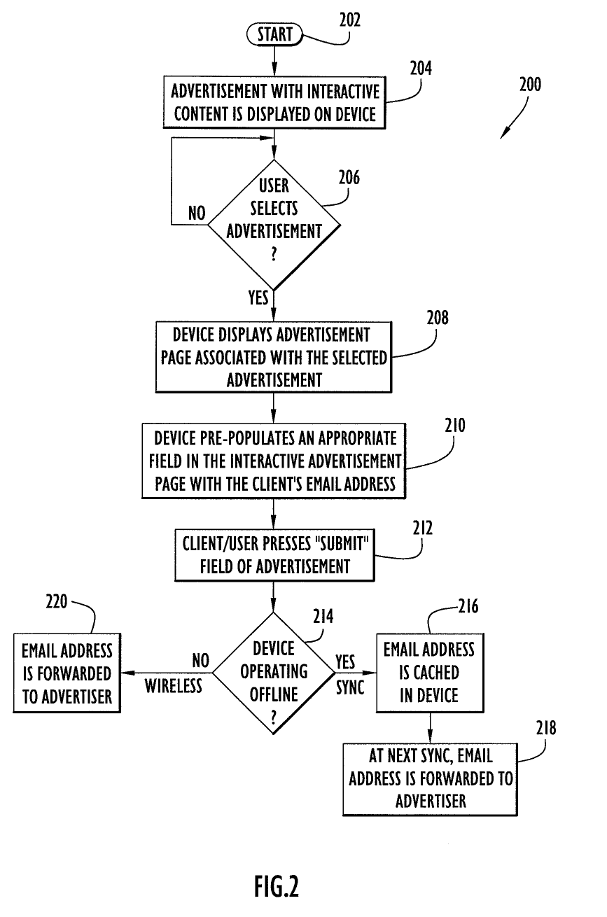

The present invention enables advertisement pages with interactive content to be displayed on mobile devices. FIG. 2 is a flow diagram illustrating a process for displaying an advertisement page on a mobile device home page according to an embodiment of the invention. Although FIG. 2 is described with respect to an interactive advertisement on a mobile device home page, the invention is not limited to this, but is more generally directed to any interactive advertisement mechanism on any handheld device.

The process begins in step 202, where the process immediately proceeds to step 204.

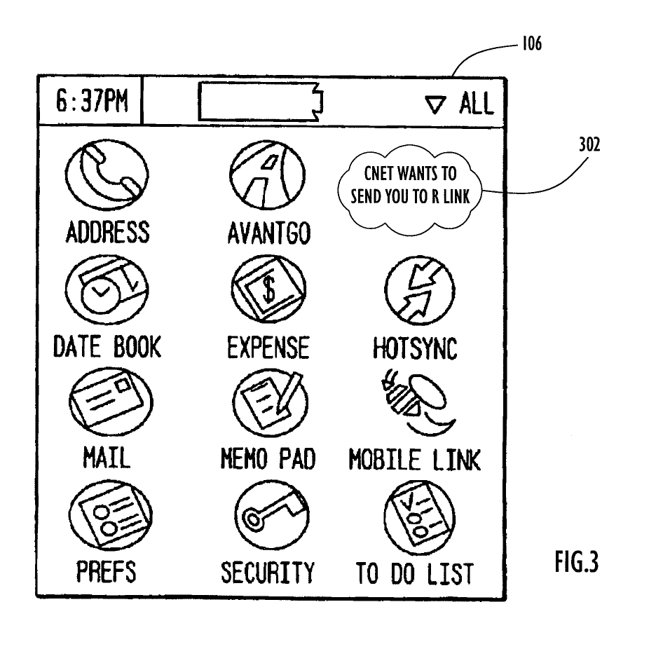

In step 204, an advertisement page with interactive content is displayed on device 106. An exemplary interactive advertisement is shown on device 106 in FIG. 3. The interactive advertisement “CNET Wants To Send You To R Link” 302 is displayed on a Palm device 106.

Returning to FIG. 2, the user has the option of selecting the advertisement displayed in step 204. In step 206, if the user selects the advertisement, the process then proceeds to step 208.

In step 208, device 106 displays an advertisement page associated with the selected advertisement on the device screen. For example, if the user selects the interactive advertisement “CNET Wants To Send You To R Link” 302, device 106 will display the advertisement page associated with the interactive advertisement “CNET Wants To Send You To R Link” 302 on the screen of device 106. In an embodiment, the advertisement page includes an email form where the user can send an email to the advertiser. The content and purpose of the email are application dependent. For example, the user might wish to send an email to the advertiser to subscribe to some service or product, obtain more information, or purchase some product. The process then proceeds to step 210.

In one embodiment, device 106 pre-populates an appropriate field in the email form of the interactive advertisement with the client's electronic mail (email) address in step 210. In other embodiments, other information regarding client 108 could be pre-populated in the email address, such as a residential address, a business address, or other address location information. The idea being that the advertiser may wish to have the client's email address or other address location information to send the client 108 further information, or otherwise communicate with the user. The process then proceeds to step 212.

In step 212, when the user is ready to send the email to the advertiser, the user presses a submit button associated with the pre-populated advertisement field. The process proceeds to step 214.

In step 214, it is determined whether device 106 is operating offline or is communicating directly with server 104 via a wireless connection. In an embodiment where device 106 is operating offline, the process proceeds to step 216.

In step 216, the email message, including the email address or other address location information of the user is cached in device 106. The process then proceeds to step 218.

In step 218, during the next sync, the email address or other address location information (as well as any other information the user may have entered into the email) are forwarded to the advertiser. In one embodiment, the address location information is forwarded by directly sending it to the advertiser via server 104. In another embodiment, the address location information is sent from device 106 to server 104, where server 104 forwards the email address or other address location information (as well as any other information) to the advertiser.

Returning to step 214, in an embodiment where client 108 is communicating directly with server 104 via a wireless or some other connection, step 220 is performed.

In step 220, the email address or other address location information from the pre-populated advertisement field (as well as any other information) are forwarded to the advertiser. In one embodiment, the address location information (as well as any other information) are forwarded by directly sending it to the advertiser via server 104. In another embodiment, the address location information (as well as any other information) are sent to server 104, where server 104 forwards it to the advertiser.

In one embodiment, the business model for displaying advertisements with interactive content on mobile devices requires the advertiser to pay server 104 a base fee plus a fee for each address location information that is sent to the advertiser, subject to a cap. However, this business model may be adjusted depending on the applicable application specific characteristics.

2.1 Content Specific Interactive Advertising on Mobile Devices

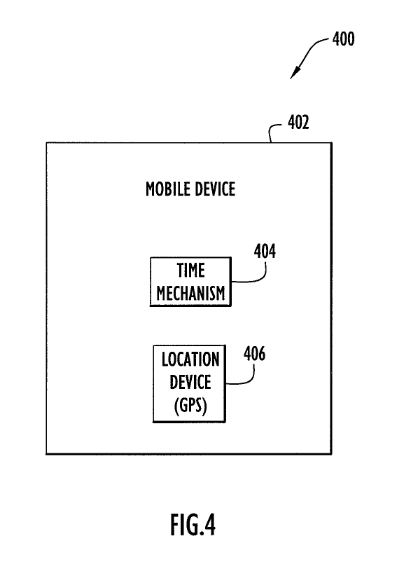

FIG. 4 is a block diagram 400 of a mobile device 402, similar to device 106. Mobile device 402 comprises a time mechanism 404 and a location device 406. Time mechanism 404 is used to track time of day functions. Location device 406 is used to track the location of mobile device 402. Location device 606 may be a GPS (Global Positioning System) module.

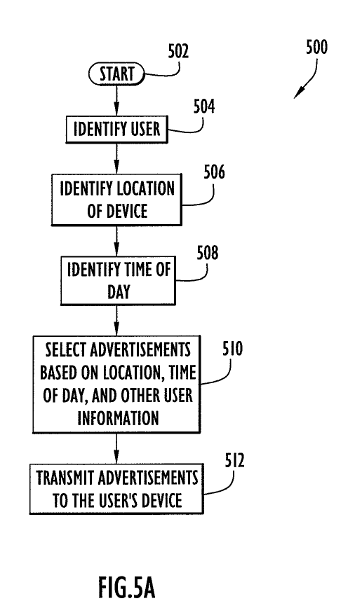

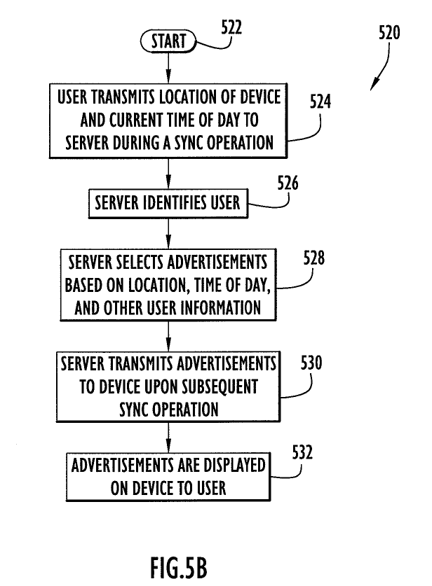

An embodiment of the present invention also enables location/time specific interactive advertisements to be displayed on handheld devices, such as mobile device 402. FIG. 5A illustrates a content specific advertising method 500 according to an embodiment of the invention. According to method 500, device 402 and server 104 communicate with each other via a wireless link or some other communication link. Thus, method 500 operates in real time. Alternatively, method 500 could operate in a time delayed mode of operation where the advertisements are downloaded to the user's device when the user performs a sync, and then subsequently displayed.

Server 104 transmits advertisements for display on device 402 via a wireless or some other connection. In one embodiment of the invention, the advertisements transmitted to device 402 are specific to the characteristics/preferences of client 108 on device 402. For example, if the time of day is lunch time and the user is defined as being a teenager, then an advertisement relating to a restaurant suitable for teenagers may be transmitted to client 108 on device 402. Alternatively, if the user is a mother, then an advertisement suitable for people with children may be transmitted to client 108 on device 402. The location of device 402 will also determine which advertisements are transmitted to device 402. For example, the restaurant advertised in the above example will be one that is in close proximity to the location of device 402.

In yet another example, suppose a user crosses the George Washington bridge in Washington, D.C. to and from work each day at approximately 8 a.m. and 5:30 p.m., respectively. At 5:15 p.m., a terrible accident occurs on the George Washington bridge that causes a traffic backup of approximately one hour. An advertisement or other informational message that provides alternative routes when traffic jams occur will be transmitted to client 108 of the user's device 402 at approximately 5:20 p.m. to alert the user of the alternate route service provided by the advertiser and provide the user with an alternate route to the user's destination, such as the user's residential address. In an embodiment, the user pays a fee for this service.

Referring now to FIG. 5, the process begins with step 502, where the process immediately proceeds to step 504.

In step 504, client 108 of device 402 is identified by server 104. Server 104 obtains information related to the user of device 402, such as the user's profile. The process then proceeds to step 506.

In step 506, the location of device 402 is identified at device 402 using location device 406 (or the user could input this information). This location information is transmitted to server 104. The process proceeds to step 508.

In step 508, the current time of day is identified at device 402 using time mechanism 404 (or the user could enter this information). This time/date information is transmitted to server 104. In an alternative embodiment, time mechanism 404 may be located in server 104. The process proceeds to step 510.

In step 510, server 104 selects one or more advertisements based on the user information identified in step 504, the location of device 402 identified in step 506, and the time of day identified in step 508. The process then proceeds to step 512.

In step 512, server 104 transmits the advertisements to device 402 for display to the user.

As previously stated, location/time specific interactive advertisements may be displayed on handheld devices in a time delayed mode of operation. In this embodiment, the advertisements are downloaded to the user's device when the user performs a sync, and then subsequently displayed. FIG. 5B is a flow diagram illustrating a method 520 for offline content specific advertising according to an embodiment of the present invention. The process begins with step 522, where the process immediately proceeds to step 524.

In step 524, device 402 transmits the location of device 402 and the current time of day upon syncing device 402 with server 104. The location of device 402 and the current time of day are identified at device 402. The location of device 402 is identified using location device 406 and the current time of day is identified using time mechanism 404. In another embodiment, current time of day is identified at server 104 using a time mechanism 404 located in server 104. This eliminates the need to transmit the current time of day from device 402 to server 104 during the sync operation. In yet another embodiment, the user enters the location of the device and the time of day for which advertisements should be selected. For example, suppose a user is going to the National Theatre in Washington, D.C. at 7:30 p.m. to see a play. The play ends at 10 p.m., and the user loves Italian food. Prior to attending the play, the user may submit the location of the National Theatre and the time of day of 10 p.m., and sync this information to server 104. The user's profile indicates that the user loves Italian food. Thus, one of the advertisements returned to the user may be one for an Italian restaurant in the location of the National Theatre that is still open at 10 p.m. The process then proceeds to step 526.

In step 526, client 108 of device 402 is identified by server 104. Server 104 obtains information related to the user of device 402, such as the user's profile. The process then proceeds to step 528.

In step 528, server 104 selects one or more advertisements based on the user information identified in step 526, the location of device 402 identified in step 524, and the time of day identified in step 524. The process then proceeds to step 530.

In step 530, server 104 transmits one or more advertisements to device 402 during a subsequent sync of device 402. The process then proceeds to step 532.

In step 532, one or more advertisements are displayed to the user on device 402. Although there is a time delay imposed when device 402 operates in an offline mode, the delay is controlled by the user of device 402. If the user desires to view advertisements immediately, the user will perform the subsequent sync of device 402 within a short predefined time period. If the need to view the advertisements is not an immediate one for the user, the user may perform the subsequent sync of device 402 at a later time.

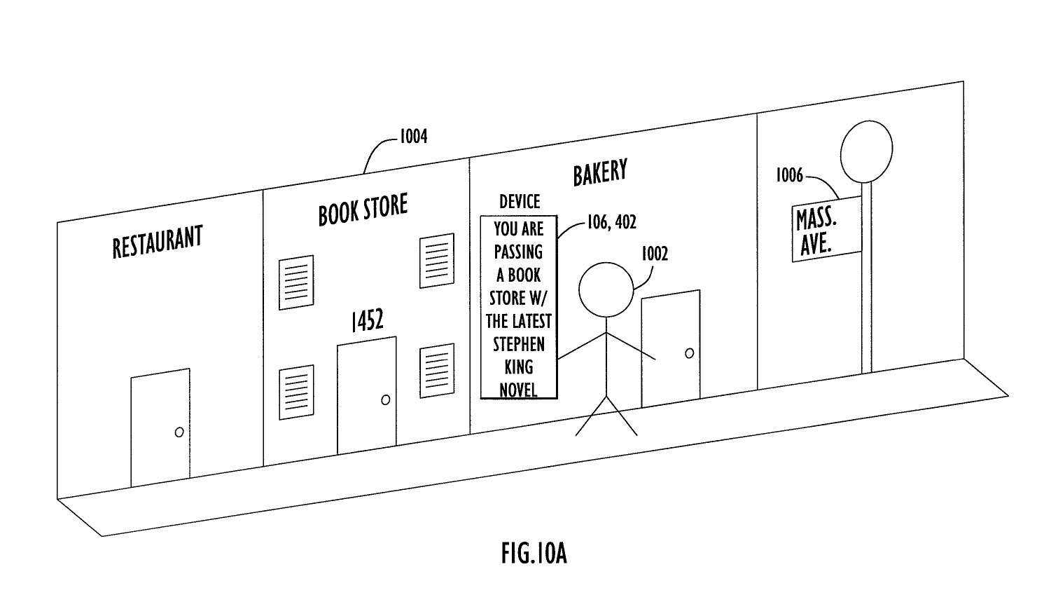

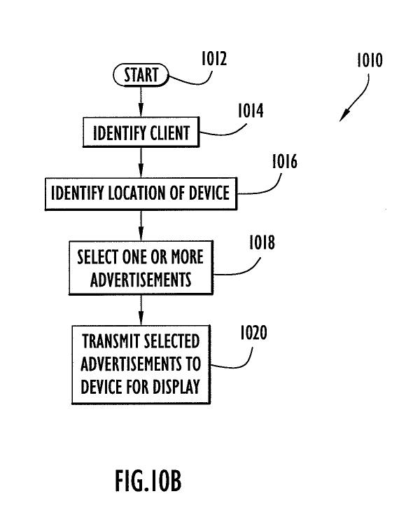

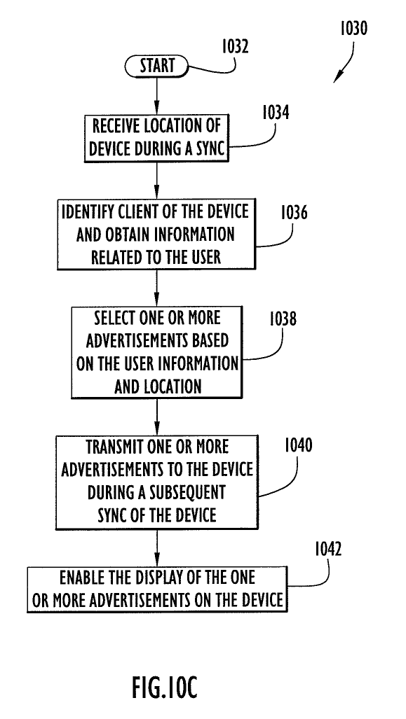

In another embodiment of the present invention, location specific interactive advertisements may be displayed on handheld devices, such as mobile device 402. FIG. 10A illustrates an example of a location specific interactive advertisement to be displayed on mobile device 402. In FIG. 10A, an individual 1002 having mobile device 402 is passing by a book store 1004 on a street 1006, such as Massachusetts Avenue.

Server 104 transmits advertisements for display on device 402 via a wireless or some other connection. In one embodiment, the advertisements transmitted to device 402 are specific to the characteristics/preferences of individual 1002. For example, the characteristics/preferences of individual 1002 include reading thriller novels, such as novels authored by Stephen King. The location of device 402 is continuously being transmitted to server 104. Knowing the location of individual 1002 and a preference of individual 1002 to read thriller novels by Stephen King, server 104 may download an advertisement from a web site or other source for bookstore 1004 that may include thriller novels, especially those authored by Stephen King. As individual 1002 approaches bookstore 1004, the advertisement will be displayed on device 402.

FIG. 10B is a method 1010 for displaying location specific interactive advertisements on mobile device 402 according to an embodiment of the invention. The process begins with step 1012, where the process immediately proceeds to step 1014.

In step 1014, client 108 of device 402 is identified by server 104. Server 104 obtains information related to individual 1002 of device 402, such as the user profile. The process then proceeds to step 1016.

In step 1016, the location of device 402 is identified at device 402 using location device 406. The location information is transmitted to server 104. In another embodiment, individual 1002 may also input their location and send the location information to server 104. The process then proceeds to step 1018.

In step 1018, server 104 selects one or more advertisements based on the user profile for individual 1002 and the location of device 402 identified in step 1016. In an embodiment of the present invention, server 104 may select all advertisements based on the location of device 402 identified in step 1016 regardless of the user profile for individual 1002. The process then proceeds to step 1020.

In step 1020, server 104 transmits the selected advertisements to device 402 for display to individual 1002.

Location specific interactive advertisements may also be displayed on handheld devices in a time delayed mode of operation. In this embodiment, the advertisements are downloaded to the user's device when the user performs a sync, and then subsequently displayed. FIG. 10C is a flow diagram illustrating a method 1030 for offline content specific advertising according to an embodiment of the present invention. The process begins with step 1032, where the process immediately proceeds to step 1034.

In step 1034, device 402 transmits the location of device 402 upon syncing device 402 with server 104. The location of device 402 is identified at device 402. The location of device 402 is identified using location device 406. In another embodiment, the user enters the location of the device for which advertisements should be selected. The process then proceeds to step 1036.

In step 1036, client 108 of device 402 is identified by server 104. Server 104 obtains information related to the user of device 402, such as the user's profile. The process then proceeds to step 1038.

In step 1038, server 104 selects one or more advertisements based on the user information identified in step 1036 and the location of device 402 identified in step 1034. The process then proceeds to step 1040.

In step 1040, server 104 transmits one or more advertisements to device 402 during a subsequent sync of device 402. The process then proceeds to step 1042.

In step 1042, one or more advertisements are displayed to the user on device 402. Although there is a time delay imposed when device 402 operates in an offline mode, the delay is controlled by the user of device 402. If the user desires to view advertisements immediately, the user will perform the subsequent sync of device 402 within a short predefined time period. If the need to view the advertisements is not an immediate one for the user, the user may perform the subsequent sync of device 402 at a later time.

In each of the above-described time/location and location specific advertisement methods, the advertisements may include interactive content. The interactive content may include, but is not limited to, an entry field for a user to send his/her email address or other address location information to the advertiser, a button(s) that the user may press to request more information about the advertisement, forms enabling the user to order products or services offered by the advertiser, and/or other types of interactive content.

2.2 Advertiser Marketing of Advertisements

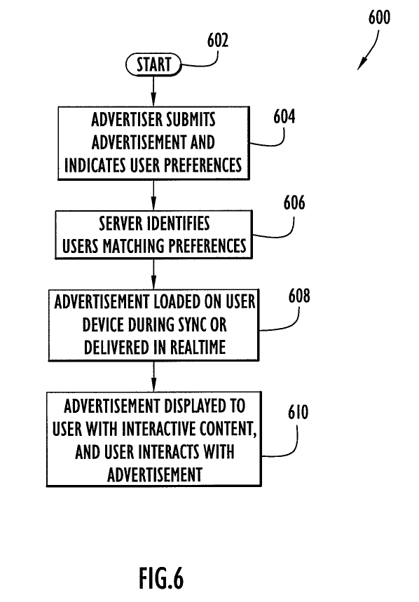

An embodiment of the present invention also allows advertisers to target users who fit certain characteristics, such as user demographics, likes, and dislikes. This may potentially increase favorable responses, reactions, and click throughs or hits to the advertiser's web page by such users. In this embodiment, advertisers contact and interact with such users via their devices 106 and the server 104. FIG. 6 is a flow diagram illustrating an advertiser targeted marketing process 600. Process 600 begins with step 602, where the process immediately proceeds to step 604.

In step 604, an advertiser submits to server 104 an advertisement and/or other materials along with user preferences, where the user preferences indicate the type of users that the advertiser would like to target. The process proceeds to step 606.

In step 606, server 104 identifies users that match the user preferences provided by the advertiser in step 604. The process then proceeds to step 608.

In step 608, the advertisement and/or other materials provided by the advertiser in step 604 are loaded on the users' devices 106 that are identified in step 606. This may occur in an offline or a connected mode of operation. In an offline mode of operation, during a sync operation, the advertisement and/or other materials are loaded on the users' devices 106. In a connected mode of operation, the advertisement and/or other materials are delivered to the users' devices in real time or near real time.

The advertisement may include interactive content. For example, the advertisement may include an offer for the user to send his/her email address or other address location information to the advertiser to obtain additional information or other services using the process described above. In another embodiment, the advertisement may have buttons which the user may press to receive additional information from the advertiser immediately. The advertisement may also include forms enabling the user to order products or services offered by the advertiser. Such interaction between the user and the advertisement material is represented by step 610 in FIG. 6.

### 3. Revenue Sharing

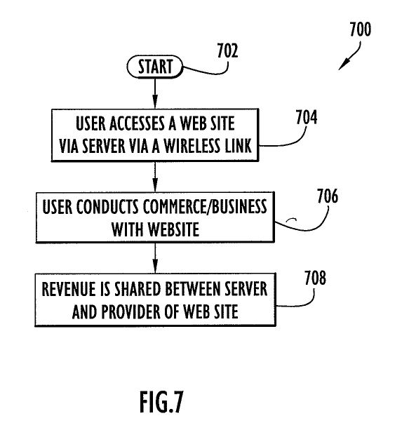

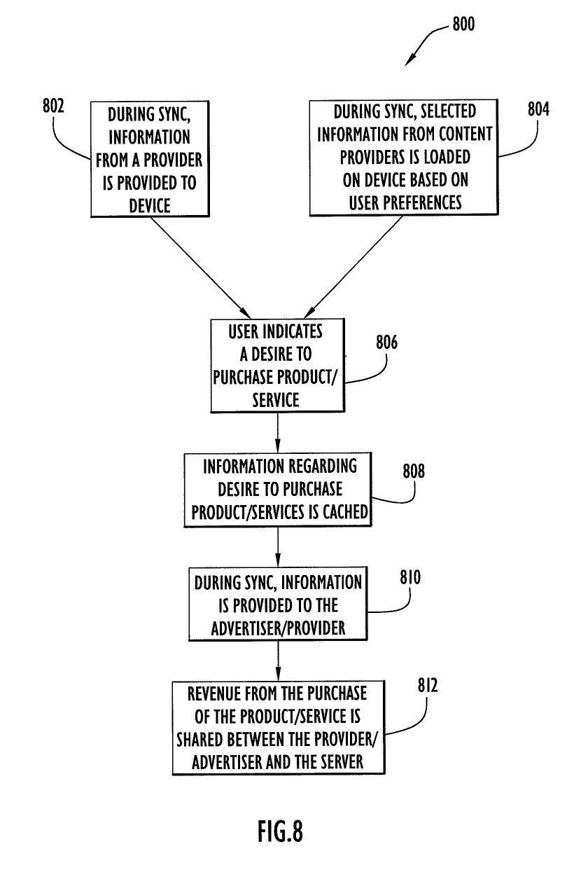

An embodiment of the present invention also provides a method of revenue sharing between servers and providers when commerce is conducted by client 108 of device 106. In such cases, for example, server 104 acts as an ISP or a gateway to the providers 128. FIG. 7 is a flow diagram illustrating a method for sharing revenue between servers, such as server 104, and providers, such as providers 128. The process begins with step 702, where the process immediately proceeds to step 704. In step 704, the user accesses a web site via server 104. In one embodiment, the user accesses the web site via server 104 in real time, where device 106 and server 104 are connected via a wireless link or some other communication link. In another embodiment, the user accesses the web site via server 104 while device 106 is operating in an offline mode. This method is described below with reference to FIG. 8. The process proceeds to step 706.

In step 706, the user conducts commerce/business with the web site. For example, the user could order a book, CD, or DVD from AMAZON.COM after navigating to AMAZON.COM via server 104. The process then proceeds to step 708.

In step 708, revenue from the commerce/business conducted in step 706 is shared with server 104. Referring to the example above, the revenue from the book, CD, or DVD purchased from AMAZON.COM is shared between Amazon.com and server 104 according to some agreement between the parties.

FIG. 8 is a flow diagram illustrating a method of revenue sharing between a server and a provider when device 106 is operating in an offline mode. In one embodiment, during a sync, information from providers in the user's subscribed channels are provided to device 106 in step 802. Such information might be, for example, a listing of new books sold on Amazon.com or articles on sale for pets at Pets.com. In another embodiment, during a sync, information from content providers is loaded on device 106 based on user preferences in step 804. For example, a user may have previously indicated that he/she would like to be informed when new books by Sydney Sheldon are published. Thus, advertisements indicating new books by Sydney Sheldon from such content providers as Barnes and Noble, Amazon.com, etc. will be loaded on device 106 during the sync. In another example, a user may establish bid requirements for a particular article being auctioned at a web site, such as Ebay, in which case information regarding the auction of the particular article are transmitted to the user during a sync operation in step 804. The process proceeds from either step 802 or step 804 to step 806.

In step 806, the user reviews the information provided in steps 802 and/or 804, and indicates the desire to purchase a product or service. The process then proceeds to step 808.

In step 808, the information regarding the user's desire to purchase the product or service is cached on device 106. The process proceeds to step 810.

In step 810, during the next or some other subsequent sync, the cached information is provided to the advertiser/provider 128. The process proceeds to step 812.

In step 812, the revenue from the purchase of the product or service is shared between advertiser/provider 128 and server 104.

### 4. Dynamic Advertisement Rotation on a Mobile Device

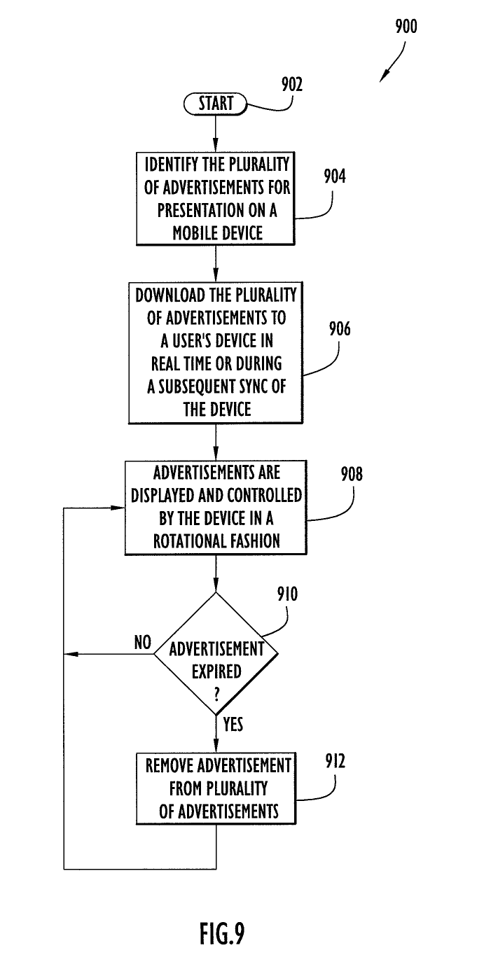

In an embodiment of the present invention, a plurality of advertisements may be downloaded from server 104 during a sync operation of a mobile device, such as device 106 or 402, and viewed in a rotational fashion on mobile device 106 or 402. In another embodiment, server 104 and a mobile device, such as mobile device 106 or 402, may communicate with each other via a wireless link or some other communication link to provide a plurality of advertisements for display on mobile device 106 or 402. FIG. 9 is a flow diagram illustrating dynamic advertisement rotation on a mobile device 402. The process begins with step 902, where the process immediately proceeds to step 904.

In step 904, a plurality of advertisements are identified for presentation on device 106 or 402. In one embodiment, the advertisements are targeted for certain users of device 106 or 402 by advertisers. For example, advertisers submit to server 104 advertisements and/or other materials along with user preferences, where the user preferences indicate the type of users that the advertiser would like to target. Server 104 then identifies users that match the user preferences provided by the advertiser as described above.

In another embodiment, server 104 selects advertisements based on user preferences, where the user preferences are identified by the individual users. For example, a user may set a bit in the user's preferences that indicates the user is interested in books authored by Stephen King. Server 104 will then listen for any reliable transmission via a transport protocol, such as IRDA (Infrared Data Association), a wireless modem, a serial port, local RF (Radio Frequency), etc. Transport protocols are well known to those skilled in the relevant art(s). The transmission may be from, for example, a URL, a broadcast across a transport protocol, a broadcast across a pager network or other computer network, etc. Software on server 104 will scan the transmitted information and select all advertisements that are related to books authored by Stephen King.

In yet another embodiment, server 104 is listening to all advertisements and selects each advertisement that it finds. The process proceeds to step 906.

In step 906, the plurality of advertisements are downloaded to a user's device 106 or 402. In one embodiment, the advertisements are downloaded in real time using a wireless connection or some other connection. In an offline embodiment, the advertisements are downloaded during a subsequent sync operation of device 106 or 402. The process proceeds to step 908.

In step 908, the plurality of advertisements are dynamically displayed on device 106 or 402 in a rotational fashion, one or more advertisements at a time. In one embodiment, all users with one or more of the same preference bits set may be grouped together by an administrator of server 104. For example, the administrator may group all users with a preference bit set that indicates that the users are interested in books authored by Stephen King. Advertisements relating to books authored by Stephen King that are obtained by server 104 are simultaneously downloaded to each user in the group.

In one embodiment, the placement of the advertisements and the length of time in which each advertisement is displayed is controlled by device 106 or 402. In another embodiment, the placement of the advertisements and the length of time in which each advertisement is displayed is controlled by server 104. In one embodiment, users may interact with the advertisements. Such interaction may include, but is not limited to, providing an email address to the advertiser, requesting more information about the advertisement, ordering products or services offered by the advertiser, and/or other types of interactive content. The process then proceeds to step 910.

In step 910 it is determined whether the advertisement being displayed has expired. If the advertisement has not expired, the process proceeds back to step 908, where the plurality of advertisements are displayed in a rotational fashion.

Returning to step 910, if the advertisement being displayed has expired, the process proceeds to step 912.

In step 912, the expired advertisement is removed from the plurality of advertisements. The process then proceeds to step 908, where the plurality of advertisements are displayed in a rotational fashion.

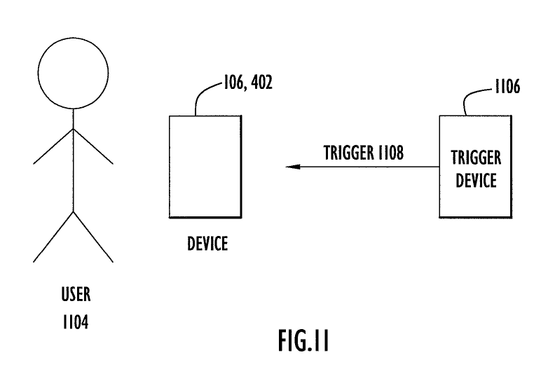

Many mobile devices may have built-in transport mechanisms, such as a wireless modem, an IRDA, local RF, etc., that enable the mobile devices to communicate with other devices or sources that also have such transport mechanisms. In an embodiment where mobile devices have built-in transport mechanisms, other devices or sources having built-in transport mechanisms may trigger the display of an advertisement on a handheld device. FIG. 11 is an exemplary illustration of other devices or sources that may trigger the display of one or more advertisements on a mobile device according to an embodiment of the present invention. FIG. 11 shows a user 1104 having a mobile device (106 or 402), a trigger source or device 1106, and a trigger 108 emanating from trigger source 1106. Mobile device 106 or 402 has one or more transport mechanisms, such as a wireless modem, an IRDA, a local RF, etc. Trigger source 1106 may be, but is not limited to, any electronic device that may provide some type of advertising. In one embodiment, trigger source 1106 has a transport mechanism. Trigger 1108 represents data transmitted from trigger source 1106. The data may include, but is not limited to, a query that asks the user if they are interested in the product or service that the advertiser offers, information about the product or service offered by the advertiser, a URL, web content, one or more channels, etc.

In one embodiment, device 106 or 402 receives one or more triggers 1108 from a plurality of trigger sources 1106 via the transport mechanism of device 106 or 402. Upon receipt of one or more triggers 1108, device 106 or 402 determines which triggers are of interest to device 106 or 402 and transmits that information to server 104. Server 104 will retrieve one or more advertisements corresponding to one or more triggers 1108, and download the corresponding one or more advertisement to device 106 or 402 for display to the user.

In another embodiment, trigger sources 1106 may include providers that are in a partnership relationship with server 104. In this embodiment, advertisements from such trigger sources 1106 may be displayed on device 106 or 402 via the transport mechanism of device 106 or 402. In one embodiment, device 106 or 402 may select only those advertisements that are of interest based on user preferences to be displayed. In another embodiment, device 106 or 402 may allow each and every advertisement that it receives to be displayed on device 106 or 402. The business model for providers that partner with server 104 for displaying advertisements with interactive content on mobile device 106 or 402 requires the providers to pay a base fee to server 104 each time an advertisement is placed on a mobile device, subject to a cap.

In one embodiment of the present invention, advertisers that partner with server 104 may provide advertisements on billboards or signs that have a transport mechanism for enabling communication between the advertiser and the user of mobile device 106 or 402. The transport mechanism of the billboard or sign may also connect to the advertiser's computer system via server 104.

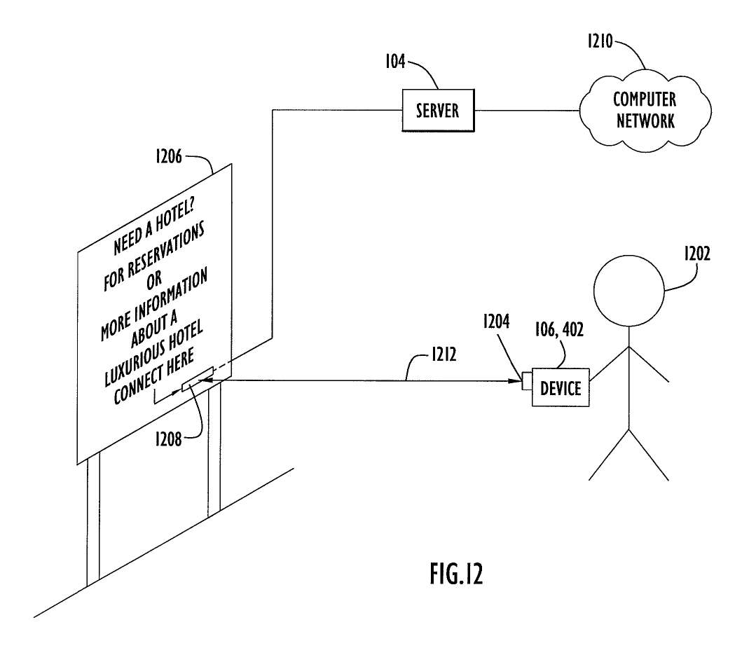

FIG. 12 is an exemplary diagram illustrating a billboard advertisement that enables communication between an advertiser and a user of a mobile device via transport mechanisms. FIG. 12 shows a user 1202, device 106 or 402 having a transport mechanism 1204, a billboard advertisement 1206 having a transport mechanism 1208, server 104, and a computer network 1210. In this example, billboard advertisement 1206 is located at an airport terminal and is owned by a prestigious hotel chain that is in partnership with server 104. Transport mechanism 1208 is connected to server 104, which in turn is connected to computer network 1210. Server 104 may provide a URL, web content, channels, or other information pertaining to the hotel chain. Computer network 1210 may be a computer owned by the hotel chain of billboard advertisement 1206. In this example, transport mechanisms 1204 and 1208 are IRDA transport mechanisms. One skilled in the relevant art(s) would know that other types of transport mechanisms may be employed.

User 1202, after arriving at his/her destination, needs hotel accommodations. User 1202, upon seeing billboard advertisement 1206, uses device 106 or 402 to connect to computer network 1210 via server 104 using transport mechanisms 1204 and 1208 by positioning device 106 or 402 so that transport mechanism 1204 is coupled to transport mechanism 1208. Server 104 transmits an advertisement retrieved from computer network 1210 to device 106 or 402 via transport mechanisms 1208 and 1204, respectively for display on device 106 or 402. The advertisement may include, for example, the name, location, and telephone number of the hotel, information about the hotel, and an interactive form to enable user 1202 to make reservations. User 1202 may transmit the form back to computer 1210 via server 104 after completing the form to try and obtain hotel reservations. Server 104 will transmit a confirmation number from computer 1210 if hotel accommodations are available or a notification from computer 1210 indicating that the reservation cannot be confirmed.

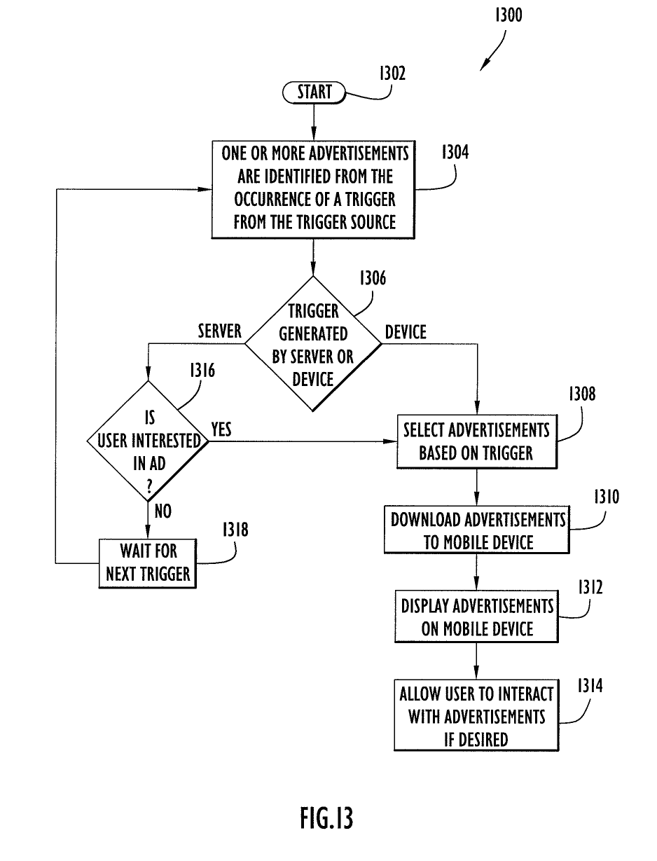

FIG. 13 is a flow diagram illustrating a method for enabling an advertiser to communicate with a user of a mobile device via a transport mechanism on a billboard advertisement. The process begins with step 1302, where the process immediately proceeds to step 1304.

In step 1304, one or more advertisements are identified by the occurrence of a trigger from a trigger source. The trigger source may be, but is not limited to, server 104, device 106 or 402, etc. The trigger may be, but is not limited to, a GPS location, a zip code, a query, etc. In the example in which location specific advertisements are displayed on device 106 or 402 (see FIG. 10A), the trigger source is device 106 or 402 which initiates the process by sending GPS location information to server 104. The corresponding trigger is the user's GPS location that is sent to server 104 from device 106 or 402. Alternatively, in the billboard advertisement example (see FIG. 12), the trigger source is server 104 which initiates the process by sending a query via billboard advertisement 1206 to device 106 or 402 through transport mechanisms 1208 and 1204. The corresponding trigger is the query (or advertisement) transmitted from server 104 to device 106 or 402 inquiring as to whether the user is interested in obtaining information on hotel reservations. The process then proceeds to decision step 1306.

In decision step 1306, it is determined whether the trigger was generated by server 104 or device 106 or 402. If the trigger was transmitted by device 106 or 402, the process proceeds to step 1308.

In step 1308, advertisements associated with the trigger are selected by server 104. In the example shown in FIG. 10A, the trigger indicates the location of the device as well as the identity of the user. The process then proceeds to step 1310.

In step 1310, the selected advertisements are downloaded to device 106 or 402. The process then proceeds to step 1312.

In step 1312, the advertisements selected in step 1310 are displayed on device 106 or 402. In step 1314, a user of device 106 or 402 may interact with the advertisements displayed on device 106 or 402 as described above. The process then proceeds to step 1318.

In step 1318, the process waits for the next trigger. Upon receiving the next trigger, the process proceeds back to step 1304.

Returning to decision step 1306, if the trigger was transmitted by server 104, the process then proceeds to decision step 1316. In decision step 1316, it is determined whether the user is interested in the advertisement. This is determined from the response of the user to the query. If the user is interested in the advertisement, the process proceeds back to step 1310 to obtain, download, and display the advertisement(s). The user may also interact with the advertisement(s), if so desired. If the user is not interested in the advertisement, the process proceeds to step 1318, to wait for the next trigger.

### 5. Conclusion

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

1-45. (canceled)

46. A method for displaying advertisements on a user device, comprising:
(1) selecting from a plurality of advertisements one or more advertisements for placement;
(2) performing one or more processing steps on the selected advertisements; and
(3) placing the processed advertisements on the device wherein the device displays the advertisements in a rotational fashion.
